(19) United States
(12) Patent Application Publication
(10) Pub. No.: US 2021/0241226 A1
(43) Pub. Date: Aug. 5, 2021

(54) ROBOTIC ARM WITH AN AUTO-CHECKOUT SYSTEM

(71) Applicant: AiFi Corp, Santa Clara, CA (US)

(72) Inventors: Ying Zheng, Santa Clara, CA (US); Steve Gu, Santa Clara, CA (US); Tyler Crain, Oakland, CA (US); Amith Iyer, San Francisco, CA (US)

(73) Assignee: AiFi Corp, Santa Clara, CA (US)

(21) Appl. No.: 16/779,595

(22) Filed: Feb. 1, 2020

(51) Int. Cl. G06Q 10/08; G06Q 30/06; B25J 9/16; G06T 1/00

(52) U.S. Cl. CPC G06Q 10/0875; G06Q 30/0633; G05B 2219/45083; G06T 1/0014; B25J 9/1697

(57) ABSTRACT

This application relates to systems, methods, devices, and other techniques for robotic arms that can be utilized with an auto-checkout system within a retail environment. This robotic arm is designed to have many functions within a store with auto-checkout system and sometimes can be utilized in a store without human cashier.

### BACKGROUND OF THE INVENTION

This application relates to systems, methods, devices, and other techniques for robotic arms that can be utilized with an auto-checkout system within a retail environment.

Methods and apparatus for using robotic arms in a vending machine for dispensing edible items such as candies and/or sodas that are first dispensed into containers before being provided to a consumer are well known and in practices. However, systems, methods, devices, and other techniques for robotic arm that can be utilized with an auto-checkout system within a retail environment need is new and could be combined with recently developed AI and machine learning.

Therefore, it is desirable to have systems, methods, devices, and other techniques for robotic arms that can be utilized with an auto-checkout system within a retail environment

### SUMMARY OF THE INVENTION

This application relates to systems, methods, devices, and other techniques for robotic arms that can be utilized with an auto-checkout system within a retail environment. This robotic arm is designed to have many functions within a store with auto-checkout system and sometimes can be utilized in a store without human cashier.

In some embodiments, the method is comprising a step of re-stocking items by the robotic arm in at least one shelves, wherein the robotic arm comprises a rotatable turret, wherein the rotatable turret comprises at least one article-retaining compartments, wherein the rotatable turret are configured to rotate, wherein the robotic arm comprises a picking device coupled to the rotatable torrents, wherein the picking device is configured to pick up the items stocked within the at least one shelves, wherein the picking device a finger-type device, a soft silicon device or a vacuum sucker, wherein the picking device is configured to store the items in the at least one article-retaining compartments, wherein the robotic arm comprises a movement device coupled to the rotatable turret, wherein the movement device is configured to move the rotatable turret vertically and horizontally, wherein a camera system is mounted on a rail system over the ceiling or on a moving cart or on the robotic arm, wherein the camera system is configured to decide whether any items need to be restocked.

In some embodiments, the method is comprising a step of organizing the at least one shelves by retuning misplaced items to right positions within the at least one shelves, wherein the camera system is configured to decide whether any items are misplaced

In some embodiments, the method is comprising a step of rotating items on the at least one shelves to show front labels of the items to customers by utilizing the rotatable turret, wherein the camera system is configured to decide whether any items have wrong face to the customers.

In some embodiments, the method comprises a step of picking items that are in an online order for packaging, wherein a program on a server is configured to receive the online order, decide where items in the online order are located, and send the robotic arm to fetch the items in the online order.

In some embodiments, the method comprises a step of ordering items when the items of certain kind are in low-stock.

In some embodiments, the method comprises a step of sending real-time notification when the items of certain kind are in low-stock.

In some embodiments, the camera system is RGB type of camera system in the method.

In some embodiments, the camera system is RGBD type camera system that is configured to locate items in 3D space.

In some embodiments, the camera system is enabled to identify misplaced items.

In some embodiments, the system in discussion relates to a robotic arm in a retail environment. In some embodiments, the robotic arm comprises a control unit, wherein the control unit gives instructions to the robotic arm and receives online orders. In some embodiments, the robotic arm comprises a rotatable turret, wherein the rotatable turret comprises at least one article-retaining compartment, wherein the rotatable turret is configured to rotate.

In some embodiments, the robotic arm comprises a picking device coupled to the rotatable turret, wherein the picking device is configured to pick up items stocked within at least one shelves, wherein the picking device a finger-type device, a soft silicon device or a vacuum sucker, wherein the picking device is configured to store the items in the at least one article-retaining compartments.

In some embodiments, the robotic arm comprises a movement device coupled to the rotatable turret, wherein the movement device is configured to move the rotatable turret vertically and horizontally, wherein a camera system is mounted on a rail system over the ceiling or on a moving cart or on the robotic arm, wherein a camera system coupled to the is configured to decide whether any items need to be restocked, wherein the camera system is configured to decide whether any items are misplaced, wherein the camera system is configured to decide whether any items have wrong face to the customers, wherein a program on a server is configured to receive the online order, decide where items in the online order, and send the robotic arm to fetch the items in the online order.

In some embodiments, the camera system is RGB type of camera system.

In some embodiments, the camera system is RGBD type camera system that is configured to locate items in 3D space.

In some embodiments, the camera system is enabled to identify misplaced items.

In some embodiments, the system in discussion relates to a robotic arm in a retail environment, comprising: a control unit, wherein the control unit gives instructions to the robotic arm and receive online orders; a rotatable turret coupled to the control unit, wherein the rotatable turret comprises at least one article-retaining compartments, wherein the rotatable turret is configured to rotate; a picking device coupled to the rotatable turret, wherein the picking device is configured to pick up items stocked within at least one shelves, wherein the picking device a finger-type device, a soft silicon device or a vacuum sucker, wherein the picking device is configured to store the items in the at least one article-retaining compartments; and a movement device coupled to the rotatable turret, wherein the movement device is configured to move the rotatable turret vertically and horizontally, wherein a camera system is mounted on a rail system over the ceiling or on a moving cart or on the robotic arm, wherein a camera system coupled to the is configured to decide whether any items need to be restocked, wherein the camera system is configured to decide whether any items are misplaced, wherein the camera system is configured to decide whether any items have wrong face to the customers, wherein a program on a server is configured to receive the online order, decide where items in the online order, and send the robotic arm to fetch the items in the online order, wherein the robot arm is configured to be connected with an auto-checkout system to identify misplaced items, items that are cluttered together, wherein the robot arm is configured to be connected with the auto-checkout system to correct erroneous receipts generated by the auto-checkout system.

In some embodiments, the camera system is RGB type of camera system.

In some embodiments, the camera system is RGBD type camera system that is configured to locate items in 3D space.

In some embodiments, the camera system is enabled to identify misplaced items.

These and other aspects, their implementations and other features are described in details in the drawings, the description and the claims.

### BRIEF DESCRIPTION OF THE DRAWINGS

FIG. 1 shows a method for using a robotic arm in a retail environment.

FIG. 2 shows an example of a robotic arm in a retail environment.

FIG. 3 shows another example of a robotic arm in a retail environment.

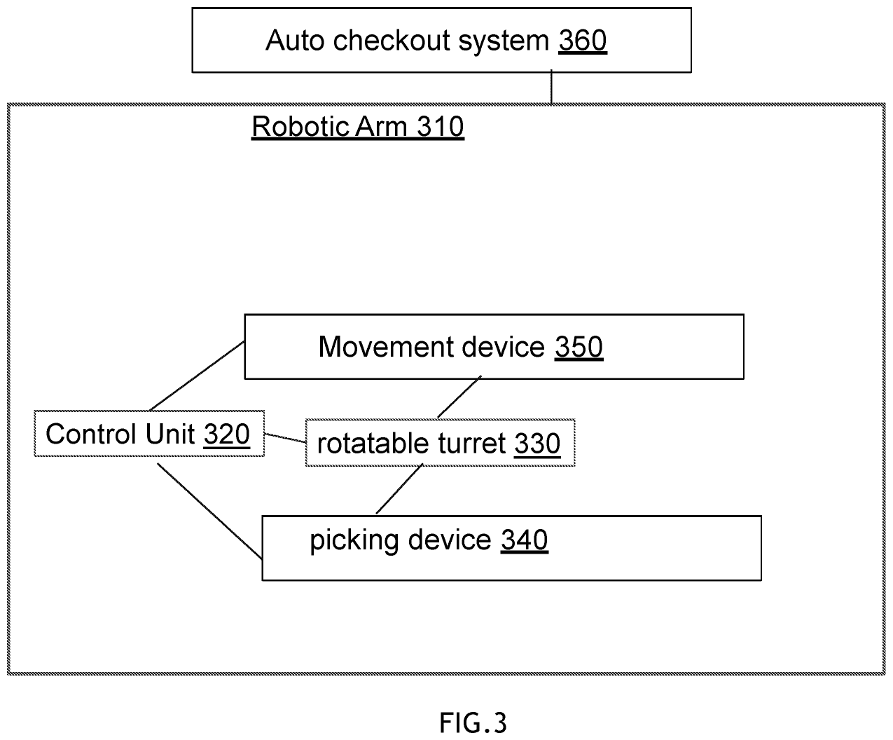

### DETAILED DESCRIPTION OF THE INVENTION

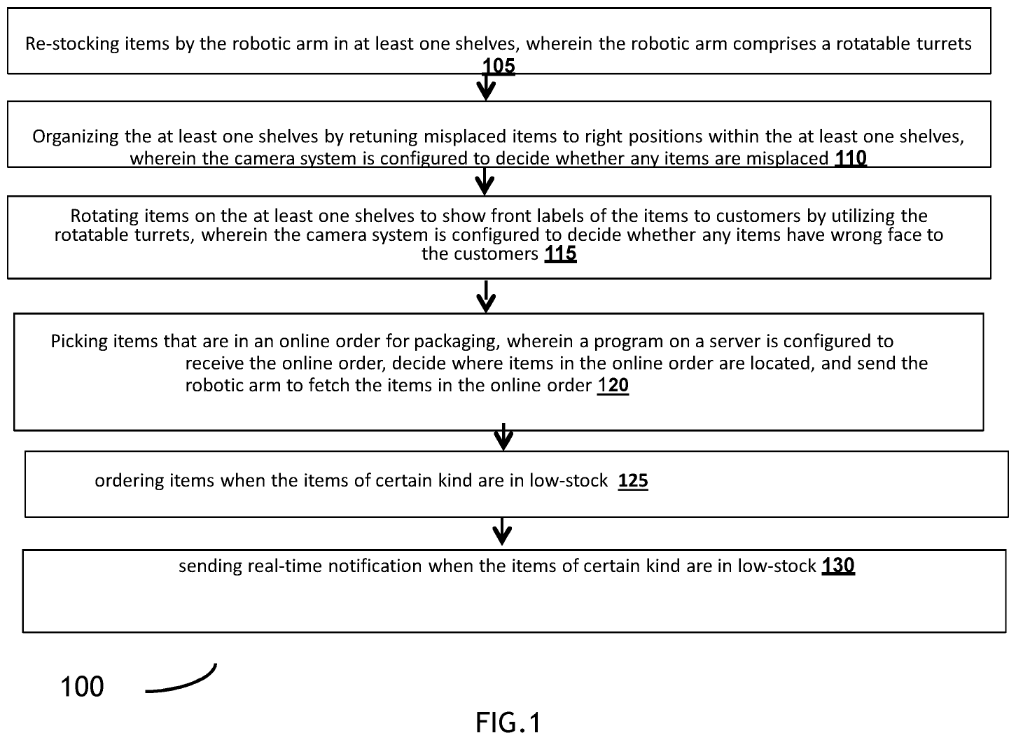

FIG. 1 shows a method 100 for using a robotic arm in a retail environment.

In some implementations, the method comprises a step 105 of re-stocking items by the robotic arm in at least one shelves, wherein the robotic arm comprises a rotatable turret, wherein the rotatable turret comprises at least one article-retaining compartments, wherein the rotatable turret are configured to rotate, wherein the robotic arm comprises a picking device coupled to the rotatable torrents, wherein the picking device is configured to pick up the items stocked within the at least one shelves, wherein the picking device a finger-type device, a soft silicon device or a vacuum sucker, wherein the picking device is configured to store the items in the at least one article-retaining compartments, wherein the robotic arm comprises a movement device coupled to the rotatable turret, wherein the movement device is configured to move the rotatable turret vertically and horizontally, wherein a camera system is mounted on a rail system over the ceiling or on a moving cart or on the robotic arm, wherein the camera system is configured to decide whether any items need to be restocked.

In some embodiments, the method comprises a step 110 of organizing the at least one shelves by retuning misplaced items to right positions within the at least one shelves, wherein the camera system is configured to decide whether any items are misplaced.

In some embodiments, the method comprises a step 115 of rotating items on the at least one shelves to show front labels of the items to customers by utilizing the rotatable turret, wherein the camera system is configured to decide whether any items have wrong face to the customers.

In some embodiments, the method comprises a step 120 of picking items that are in an online order for packaging, wherein a program on a server is configured to receive the online order, decide where items in the online order are located, and send the robotic arm to fetch the items in the online order.

In some embodiments, the method comprises a step 125 of ordering items when the items of certain kind are in low-stock.

In some embodiments, the method comprises a step 130 of sending real-time notification when the items of certain kind are in low-stock.

In some embodiments, the camera system is RGB type of camera system in the method.

In some embodiments, the camera system is RGBD type camera system that is configured to locate items in 3D space.

In some embodiments, the camera system is enabled to identify misplaced items.

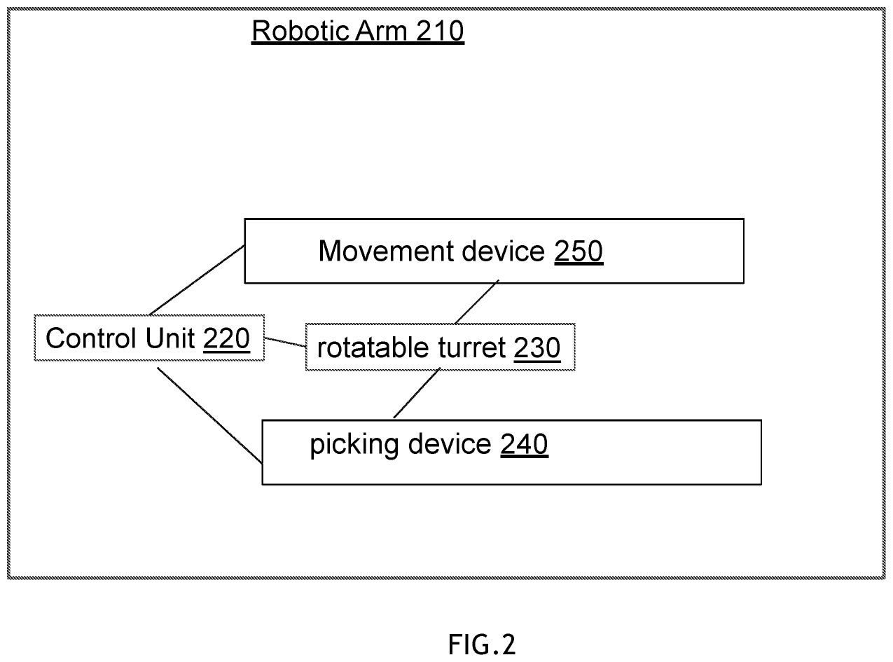

FIG. 2 shows an example of a robotic arm 210 in a retail environment.

In some embodiments, the system in discussion relates to a robotic arm in a retail environment. In some embodiments, the robotic arm 210 comprises a control unit 220, wherein the control unit 220 gives instructions to the robotic arm 210 and receives online orders. In some embodiments, the robotic arm comprises a rotatable turret 230, wherein the rotatable turret comprises at least one article-retaining compartment, wherein the rotatable turret is configured to rotate.

In some embodiments, the robotic arm comprises a picking device 240 coupled to the rotatable turret 230, wherein the picking 240 device is configured to pick up items stocked within at least one shelves, wherein the picking device 240 a finger-type device, a soft silicon device or a vacuum sucker, wherein the picking device 240 is configured to store the items in the at least one article-retaining compartments.

In some embodiments, the robotic arm comprises a movement device 250 coupled to the rotatable turret 230, wherein the movement device 250 is configured to move the rotatable turret 230 vertically and horizontally, wherein a camera system is mounted on a rail system over the ceiling or on a moving cart or on the robotic arm, wherein a camera system coupled to the is configured to decide whether any items need to be restocked, wherein the camera system is configured to decide whether any items are misplaced, wherein the camera system is configured to decide whether any items have wrong face to the customers, wherein a program on a server is configured to receive the online order, decide where items in the online order, and send the robotic arm to fetch the items in the online order.

In some embodiments, the camera system is RGB type of camera system.

In some embodiments, the camera system is RGBD type camera system that is configured to locate items in 3D space.

In some embodiments, the camera system is enabled to identify misplaced items.

FIG. 2 shows an example of a robotic arm 310 in a retail environment.

In some embodiments, the system in discussion relates to a robotic arm in a retail environment. In some embodiments, the robotic arm 310 comprises a control unit 320, wherein the control unit 320 gives instructions to the robotic arm 310 and receives online orders. In some embodiments, the robotic arm comprises a rotatable turret 330, wherein the rotatable turret comprises at least one article-retaining compartment, wherein the rotatable turret is configured to rotate.

In some embodiments, the robotic arm comprises a picking device 340 coupled to the rotatable turret 330, wherein the picking 340 device is configured to pick up items stocked within at least one shelves, wherein the picking device 340 a finger-type device, a soft silicon device or a vacuum sucker, wherein the picking device 340 is configured to store the items in the at least one article-retaining compartments.

In some embodiments, the robotic arm comprises a movement device 350 coupled to the rotatable turret 330, wherein the movement device 350 is configured to move the rotatable turret 330 vertically and horizontally, wherein a camera system is mounted on a rail system over the ceiling or on a moving cart or on the robotic arm, wherein a camera system coupled to the is configured to decide whether any items need to be restocked, wherein the camera system is configured to decide whether any items are misplaced, wherein the camera system is configured to decide whether any items have wrong face to the customers, wherein a program on a server is configured to receive the online order, decide where items in the online order, and send the robotic arm to fetch the items in the online order, wherein the robot arm 310 is configured to be connected with an auto-checkout system 360 to identify misplaced items, items that are cluttered together, wherein the robot arm 310 is configured to be connected with the auto-checkout system 360 to correct erroneous receipts generated by the auto-checkout system

In some embodiments, the camera system is RGB type of camera system.

In some embodiments, the camera system is RGBD type camera system that is configured to locate items in 3D space.

In some embodiments, the camera system is enabled to identify misplaced items.

1. A method for using a robotic arm in a retail environment, comprising:
Re-stocking items by the robotic arm in at least one shelves, wherein the robotic arm comprises a rotatable turret, wherein the rotatable turret comprises at least one article-retaining compartments, wherein the rotatable turret are configured to rotate, wherein the robotic arm comprises a picking device coupled to the rotatable torrents, wherein the picking device is configured to pick up the items stocked within the at least one shelves, wherein the picking device a finger-type device, a soft silicon device or a vacuum sucker, wherein the picking device is configured to store the items in the at least one article-retaining compartments, wherein the robotic arm comprises a movement device coupled to the rotatable turret, wherein the movement device is configured to move the rotatable turret vertically and horizontally, wherein a camera system is mounted on a rail system over the ceiling or on a moving cart or on the robotic arm, wherein the camera system is configured to decide whether any items need to be restocked;
Organizing the at least one shelves by retuning misplaced items to right positions within the at least one shelves, wherein the camera system is configured to decide whether any items are misplaced;
Rotating items on the at least one shelves to show front labels of the items to customers by utilizing the rotatable turret, wherein the camera system is configured to decide whether any items have wrong face to the customers; and
Picking items that are in an online order for packaging, wherein a program on a server is configured to receive the online order, decide where items in the online order are located, and send the robotic arm to fetch the items in the online order.

2. The method for using a robotic arm in a retail environment of claim 1, further comprising: Ordering items when the items of certain kind are in low-stock.

3. The method for using a robotic arm in a retail environment of claim 1, further comprising: Sending real-time notification when the items of certain kind are in low-stock.

4. The method for using a robotic arm in a retail environment of claim 1, wherein the camera system is RGB type of camera system.

5. The method for using a robotic arm in a retail environment of claim 1, wherein the camera system is RGBD type camera system that is configured to locate items in 3D space.

6. The method for using a robotic arm in a retail environment of claim 1, wherein the camera system is enabled to identify misplaced items.

7. A robotic arm in a retail environment, comprising:
a control unit, wherein the control unit gives instructions to the robotic arm and receive online orders;
a rotatable turret, wherein the rotatable turret comprises at least one article-retaining compartments, wherein the rotatable turret is configured to rotate;
a picking device coupled to the rotatable turret, wherein the picking device is configured to pick up items stocked within at least one shelves, wherein the picking device a finger-type device, a soft silicon device or a vacuum sucker, wherein the picking device is configured to store the items in the at least one article-retaining compartments;
a movement device coupled to the rotatable turret, wherein the movement device is configured to move the rotatable turret vertically and horizontally, wherein a camera system is mounted on a rail system over the ceiling or on a moving cart or on the robotic arm, wherein a camera system coupled to the is configured to decide whether any items need to be restocked, wherein the camera system is configured to decide whether any items are misplaced, wherein the camera system is configured to decide whether any items have wrong face to the customers, wherein a program on a server is configured to receive the online order, decide where items in the online order, and send the robotic arm to fetch the items in the online order.

8. The robotic arm in a retail environment of claim 7, wherein the camera system is RGB type of camera system.

9. The robotic arm in a retail environment of claim 7, wherein the camera system is RGBD type camera system that is configured to locate items in 3D space.

10. The robotic arm in a retail environment of claim 7, wherein the camera system is enabled to identify misplaced items.

11. A robotic arm in a retail environment, comprising:
a control unit, wherein the control unit gives instructions to the robotic arm and receive online orders;
a rotatable turret coupled to the control unit, wherein the rotatable turret comprises at least one article-retaining compartments, wherein the rotatable turret is configured to rotate;
a picking device coupled to the rotatable turret, wherein the picking device is configured to pick up items stocked within at least one shelves, wherein the picking device a finger-type device, a soft silicon device or a vacuum sucker, wherein the picking device is configured to store the items in the at least one article-retaining compartments;
a movement device coupled to the rotatable turret, wherein the movement device is configured to move the rotatable turret vertically and horizontally, wherein a camera system is mounted on a rail system over the ceiling or on a moving cart or on the robotic arm, wherein a camera system coupled to the is configured to decide whether any items need to be restocked, wherein the camera system is configured to decide whether any items are misplaced, wherein the camera system is configured to decide whether any items have wrong face to the customers, wherein a program on a server is configured to receive the online order, decide where items in the online order, and send the robotic arm to fetch the items in the online order, wherein the robot arm is configured to be connected with an auto-checkout system to identify misplaced items, items that are cluttered together, wherein the robot arm is configured to be connected with the auto-checkout system to correct erroneous receipts generated by the auto-checkout system.
